(19) United States
(12) Patent Application Publication
(10) Pub. No.: US 2023/0284837 A1
(43) Pub. Date: Sep. 14, 2023

(54) Cooking Spoon

(71) Applicant: Steven J. Schoettle, Saint Simons Island, GA (US)

(72) Inventor: Steven J. Schoettle, Saint Simons Island, GA (US)

(21) Appl. No.: 17/835,644

(22) Filed: Jun. 8, 2022

(30) Foreign Application Priority Data
Mar. 14, 2022 (ES) D0533995

(51) Int. Cl. A47J 43/28

(52) U.S. Cl. CPC A47J 43/281

(57) ABSTRACT

The invention aids in grilling foods by scraping foods such as paella off of a cooking surface to prevent burning and with minimal disturbance to their visual appearance. It comprises a decorative and ergonomic handle attached to a spoon bowl shaped like a shallow spherical cap, with the edge of the spherical cap distal to the handle being truncated and formed into a straight edge for cutting.

### CROSS-REFERENCES TO RELATED APPLICATIONS

None.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A BIOLOGICAL SEQUENCE LISTING

Not applicable.

### BACKGROUND OF INVENTION

### Field of the Invention

This invention is in the field of cooking or grilling of foodstuffs, more specifically in the field of moving foodstuffs on a horizontal cooking surface during and after cooking. Still more specifically, this invention is in the field of scraping foodstuffs off of a cooking surface to prevent burning and with minimal disturbance to their visual appearance. Yet more specifically, this invention is in the field of scraping foodstuffs off of surfaces using a straight bottom edge.

### Description of the Related Art

Many cooking spoons exist, both patented and unpatented. Spoons and spatulas with more-or-less straight bottom edges have been created over time, and a variety of patents and patent applications for devices of this sort have been published since 1917. U.S. utility applications 20110192037 by Genatossio and 20060248732 by Straube, U.S. Pat. No. 4,524,513 to Intini, U.S. Pat. No. 2,574,679 to Woodburn and U.S. Pat. No. 1,121,062 to Bowman, and British patent application no. 321868 to Collins fall into this category. However, none of these teaches key aspects of the present invention.

### BRIEF DESCRIPTION OF THE INVENTION

### Objects of the Invention

The principal object of the invention is to aid in grilling foods by scraping foods such as paella off of a cooking surface to prevent burning and with minimal disturbance to their visual appearance.

### SUMMARY OF THE INVENTION

The subject invention comprises a decorative and ergonomic handle attached to a spoon bowl shaped like a shallow spherical cap, with the edge of the spherical cap distal to the handle being truncated and formed into a straight edge. The other edges of the cap may be slightly dished. Importantly, the plane of the other edges of the spherical cap is inclined with respect to the handle, and the handle is attached to the edge of the spherical cap so that the centerline of the handle rod is tangential to the sphere. The straight edge is preferably perpendicular to the axis of the handle rod, although other angles may be used and still fall within the scope of this invention.

The handle is shaped to fit comfortably into the palm of a hand, and is long enough to separate the user from the heat of a fire or a hot paella pan. The spoon bowl is shaped to scrape under the contents of a pan and hold an amount appropriate for a single serving.

These and other benefits will be more clearly illustrated in the following detailed description and drawings.

### BRIEF DESCRIPTION OF THE DRAWINGS

FIG. 1 is a perspective view of the invention.

FIG. 2 is the front view of the invention.

FIG. 3 is the rear view of the invention.

FIG. 4 is the left side view of the invention.

FIG. 5 is the right side view of the invention.

FIG. 6 is the bottom view of the invention.

FIG. 7 is the top view of the invention.

FIG. 8 is a perspective view of the invention in use.

### DETAILED DESCRIPTION OF THE INVENTION

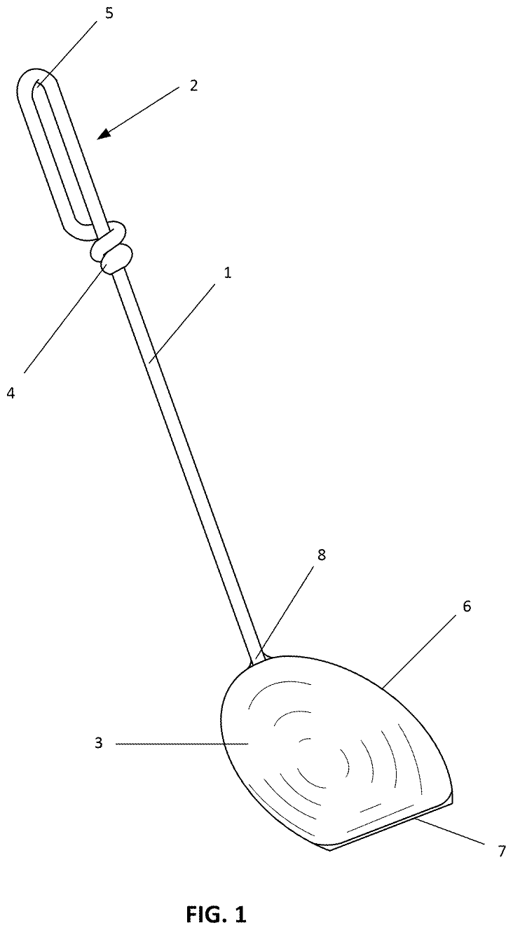

Referring now to the drawings, in which like reference characters refer to like elements among the figures, FIG. 1 is a perspective view of the invention. It is an elongate spoon made entirely, preferably, from food grade stainless steel. The scope of this invention includes any other materials known to be suitable for food preparation unless specifically limited below. The spoon is especially adapted for scraping foods such as paella from a flat-bottomed pan. Its principal features are a rod 1, a handle 2, and a spoon bowl 3. The handle 2 is formed from the top end 4 of the rod 1 by bending a portion of the rod proximate to the top end 4 in a hairpin turn 5 and securing the top end 4 to the rod 1 by twisting the top end 4 about the rod 1.

The spoon bowl 3 is in the shape of a cap section of a sphere, that is, the portion of the surface of a sphere that is removed by cutting through a sphere with a plane. The cap is further modified by cutting it along its round edge 6 to create a straight edge 7. The cap thus modified then forged to cause both the round edge 6 and the straight edge 7 to lie in the same plane.

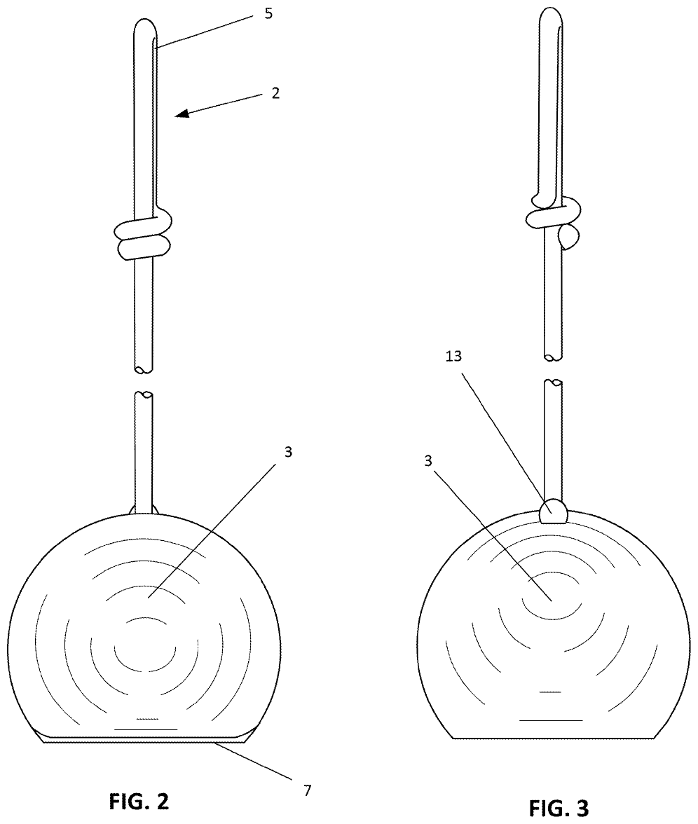

Specifically, and preferably, the invention is made by the following method. All parts are made from food grade stainless steel. First, the rod 1 is cut from 5/16 diameter stock and is beaten radially along its entire length with a pneumatic hammer and special die to tighten the grain structure of the steel. Rod stock of other diameter and non-circular cross-section may be used and fall within the scope of this invention. Then the top end 4 is heated by an oxy-polypropylene torch for bending. This type of torch is preferred because it is 200° F. cooler than oxyacetylene, preserving the grain structure and resistance to bending when cooled. The hairpin turn 5 is formed while the rod is hot, and the top end 4 is twisted around the rod 1 to complete the handle 2 and provide ornamentation thereto. Next, the bottom end 8 of the rod 1 is flared to provide a secure base for attachment of the spoon bowl 3. The flare 13 (see FIG. 2) is created on the same side of the rod 1 as the handle so that when the spoon bowl 3 is attached to the flare 13, the handle 2 is in an optimal ergonomic relationship to the spoon bowl 3.

Preferably, the spoon bowl 3 is made using a CNC machine to cut a plurality of 5″ circular blanks from a 4′×8′ sheet of 14 gauge food grade stainless, also cutting a straight edge of between 2¾″ and 3¼″ length along one side of each of the blanks. Each blank is then dished into a spherical cap shape to a depth of between ⅜ and ⅝ inch using a pneumatic hammer and a 1″ circular die. The resulting edges are forged into a coplanar relationship by hand on a table, and the straight edge 7 is then sharpened by hand. Each spoon bowl 3 is then microscopically textured by vibrating it in a ceramic medium. This permits food to stick to the spoon better than if the spoon were smooth stainless steel. Finally, the spoon bowl 3 is TIG welded to the bottom end 8 of the rod 1 so as to prevent gas bubbles from creating porosity in the weld. The weld is visually inspected to ensure the absence of gaps which would otherwise allow food particles to accumulate.

FIG. 2 is the front view of the invention. The bottom of the spoon bowl 3 is concave in this view. Note that, for optimal ergonomics, the hairpin turn 5 of the handle 2 is bent backward into the plane of the drawing. This means that the vertical plane of the hairpin turn is preferably perpendicular to the straight edge 7. The preferred dimensions of the invention are as follows: overall length, between 18 and 24 inches; the length of the handle 2, between 4 and 5 inches; the width of the spoon bowl 3 is between 4.5 and 5.5 inches; the depth of the spoon bowl is between ⅜ and ⅝ inch; and the width of the straight edge 7 is between 2.75 and 3.25 inches. Other dimensions for these elements may be used and are included within the scope of this invention. Note the flare 13 at the bottom end 8 of the rod 1, to which the center of the upper edge of the spoon bowl 3 is welded.

FIG. 3 is the rear view of the invention. The bottom of the spoon bowl 3 is convex in this view.

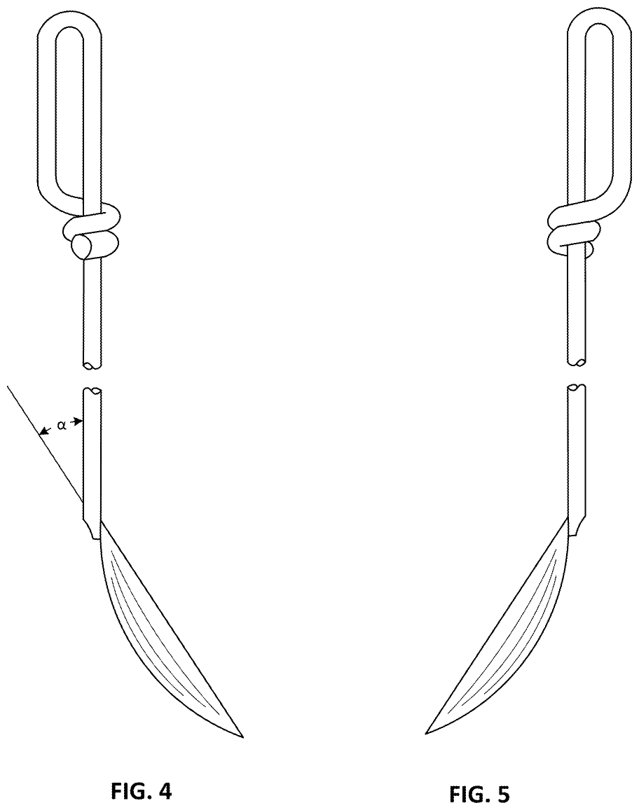

FIG. 4 is the left side view of the invention. Note that the angle α between the rod 1 and the plane occupied by the round edge 6 and the straight edge 7 is preferably between 30 and 40 degrees.

FIG. 5 is the right side view of the invention.

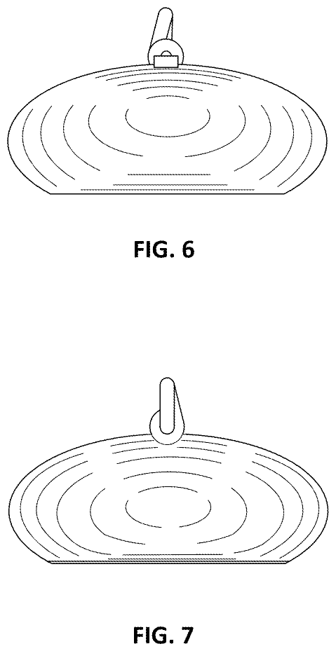

FIG. 6 is the bottom view of the invention.

FIG. 7 is the top view of the invention.

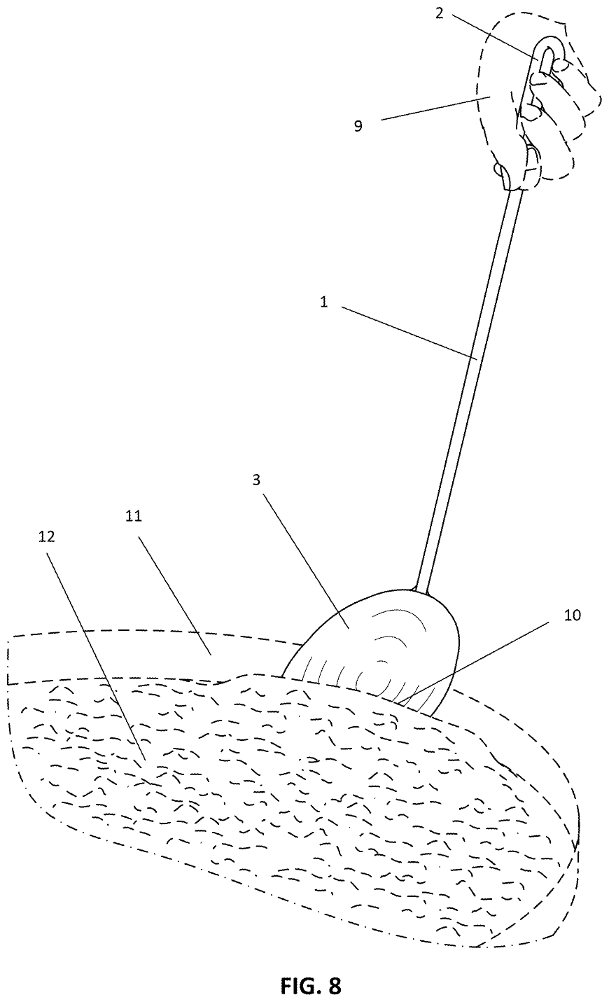

FIG. 8 is a perspective view of the invention in use. Dashed lines indicate environmental structure. Typically, this invention is intended to be used with paella and other flat pan recipes to separate the edge 10 of the food 12 from the pan 11 and lift the food 12 to inspect it during cooking or to remove a portion from the pan 11. A user's hand 9 is shown here grasping the handle 2 and inserting the straight edge 7 (not visible in this view, see FIG. 1) of the spoon bowl 3 between the food edge 10 and the edge of the pan 11. The food 12 is then lifted further to inspect the underside or to cut the food into a portion the size of the spoon bowl and serve it. Note that the rod 1 is of a length to allow the handle 2 to remain cool and to keep the hand 9 away from the heat. The straight edge 7 can also be used to cut the food 12 at any place in the pan 11 to remove a portion of any size.

Other configurations and usages of this embodiment should now be apparent to a person with cooking skill, and this embodiment and its method of making are not intended to be limited by this description.

1. A cooking spoon, comprising:
a rod having an axis, a top end, and a bottom end;
the top end comprising a handle;
a spoon bowl being in the shape of a cap section of a sphere and having a round edge;
the round edge being affixed to the bottom end so that the axis is parallel to a tangent to the sphere; and
the edge distal to the bottom end truncating the cap and being formed into a straight edge.

2. The cooking spoon of claim 1, wherein:
said round edge and said straight edge lie in a plane; and
said straight edge is perpendicular to said axis.

3. The cooking spoon of claim 2, wherein:
said straight edge is sharpened.

4. The cooking spoon of claim 2, in which:
said handle is formed from said rod by bending said rod proximate to said top end in a hairpin turn and securing said top end to said rod by twisting said top end about said rod.

5. The cooking spoon of claim 2, in which:
said spoon bowl is forged from a circular flat metal plate by beating the plate into the shape of said spoon bowl to a depth of between ⅜ and ⅝ inch, and microscopically texturing the cap by vibrating it in a ceramic medium.

6. The cooking spoon of claim 4, wherein:
the overall length of said spoon is between 18 and 24 inches;
the length of said handle is between 4 and 5 inches;
the width of said spoon bowl is between 4.5 and 5.5 inches;
the depth of said spoon bowl is between ⅜ and ⅝ inch;
the width of said straight edge is between 2.75 and 3.25 inches; and
the angle between said plane and said axis is between 30 and 40 degrees.

7. A paella spoon, comprising:
a spoon bowl having a round edge;
the spoon bowl being forged from a circular flat metal plate by cutting the round edge so that a portion of it is a straight edge, forging the plate so that a spoon bowl is formed having a depth, and so that the round edge and the straight edge lie in one plane, and microscopically texturing the spoon bowl by vibrating it in a ceramic medium.

8. The paella spoon of claim 7, further comprising:
a rod having a top end, a bottom end, and an axis;
said spoon bowl being attached to the bottom end;
said top end comprising a handle;
the handle being formed from the rod by bending the rod proximate to the top end in a hairpin turn and securing the top end to the rod by twisting the top end about the rod.

9. The paella spoon of claim 8, in which:
said straight edge is perpendicular to said axis;
the overall length of said spoon is between 18 and 24 inches;
the length of said handle is between 4 and 5 inches;
the width of said spoon bowl is between 4.5 and 5.5 inches;
the depth of said spoon bowl is between ⅜ and ⅝ inch;
the width of said straight edge is between 2.75 and 3.25 inches; and
the angle between said plane and said axis is between 30 and 40 degrees.

10. The paella spoon of claim 9, in which:
said rod is beaten radially along its entire length with a pneumatic hammer.

11. The paella spoon of claim 10, in which:
said straight edge is sharpened.

12. A method of making a cooking spoon, comprising the steps of:
(a) cutting a rod, the rod having a top end, a bottom end, and an axis, and beating it radially along its entire length with a pneumatic hammer;
(b) heating the top end, bending it into a hairpin turn, the hairpin turn lying in a hairpin plane and twisting the top end around the rod;
(c) forming a flare at the bottom end;
(d) cutting at least one circular blank having a circular edge from a sheet of steel;
(e) cutting a straight edge along one side of the at least one blank;
(f) shaping the at least one blank into a spoon bowl using a pneumatic hammer and a circular die;
(g) forging the circular edge and the straight edge of the spoon bowl into a spoon bowl plane;
(h) microscopically texturing the spoon bowl by vibrating it in a ceramic medium; and
(i) welding the spoon bowl to the flare so that the straight edge is perpendicular to the axis and the spoon bowl plane is at an angle to the axis greater than zero.

13. The method of claim 12, in which:
said rod and said sheet are food-grade stainless steel;
said top end is heated by an oxy-polypropylene torch;
said hairpin plane is perpendicular to said straight edge;
TIG welding is used to weld the spoon bowl to the flare; and
said straight edge is sharpened.

14. The method of claim 13, in which:
the overall length of said cooking spoon is between 18 and 24 inches;
the length of said handle is between 4 and 5 inches;
the width of said spoon bowl is between 4.5 and 5.5 inches;
the depth of said spoon bowl is between ⅜ and ⅝ inch;
the width of said straight edge is between 2.75 and 3.25 inches; and
the angle between said spoon bowl plane and said axis is between 30 and 40 degrees.
